(19) United States
(12) Patent Application Publication
(10) Pub. No.: US 2016/0223884 A1
(43) Pub. Date: Aug. 4, 2016

(54) PHOTOELECTRIC CONVERSION APPARATUS, IMAGING SYSTEM, AND DRIVING METHOD FOR PHOTOELECTRIC CONVERSION APPARATUS

(71) Applicant: CANON KABUSHIKI KAISHA, Tokyo (JP)

(72) Inventor: Tomoki Kususaki, Kawasaki-shi (JP)

(21) Appl. No.: 14/994,191

(22) Filed: Jan. 13, 2016

(30) Foreign Application Priority Data
Feb. 4, 2015 (JP) 2015-020294

(51) Int. Cl. G03B 13/36; G01J 1/42; G01J 1/44

(52) U.S. Cl. CPC G03B 13/36; G01J 1/44; G01J 1/4209

(57) ABSTRACT

Provided is a photoelectric conversion apparatus, including: a plurality of pixels, each of the plurality of pixels including: a photoelectric conversion unit; a charge transfer unit; and an amplification unit; a reference voltage generation unit; a comparison unit configured to output a comparison result by comparing an output voltage from the amplification unit and a reference voltage output from the reference voltage generation unit; and a control unit configured to control a timing to end the accumulation of the charges in the photoelectric conversion unit based on the comparison result, in which the reference voltage to be compared with the output voltage based on the charges transferred from the photoelectric conversion unit to the charge accumulation unit when the charge transfer unit is in a non-conductive state, is a voltage corresponding to charges accumulated in the charge accumulation unit due to a dark current.

### BACKGROUND OF THE INVENTION

1. Field of the Invention

The present invention relates to a photoelectric conversion apparatus, an imaging system, and a driving method for the photoelectric conversion apparatus.

2. Description of the Related Art

In Japanese Patent Application Laid-Open No. 2009-130396, a photoelectric conversion apparatus used for phase-difference detection auto focusing is described. This photoelectric conversion apparatus is configured to monitor an accumulation amount of photocharges generated in a photoelectric conversion unit such as a photodiode, and automatically control accumulation time of charges in consideration of a dynamic range of a circuit. This photoelectric conversion apparatus has a structure in which excessive charges overflowed from the photoelectric conversion unit to a charge-voltage conversion unit such as a floating diffusion are monitored to control the accumulation time of the charges. In this manner, a signal of a level suitable to an autofocus operation may be obtained.

In the photoelectric conversion apparatus described in Japanese Patent Application Laid-Open No. 2009-130396, a threshold voltage for detecting the excessive charges do not have a value that takes a dark current, which may be generated in the charge-voltage conversion unit, into consideration. In this case, depending on a scene to be photographed, due to an erroneous determination of the charges accumulated by the dark current generated in the charge-voltage conversion unit as the excessive charges and other such factors, an accuracy of detecting the excessive charges may be reduced, which may lead to a reduction in autofocus accuracy in some cases.

### SUMMARY OF THE INVENTION

According to one embodiment of the present invention, there is provided a photoelectric conversion apparatus, including: a pixel unit including a plurality of pixels, each of the plurality of pixels including: a photoelectric conversion unit configured to generate charges corresponding to incident light; a charge transfer unit configured to transfer the charges generated in the photoelectric conversion unit to a charge accumulation unit; and an amplification unit configured to output an output voltage corresponding to the charges accumulated in the charge accumulation unit; a reference voltage generation unit configured to generate a reference voltage; a comparison unit configured to output a comparison result by comparing the output voltage from the amplification unit and the reference voltage output from the reference voltage generation unit; and a control unit configured to control a timing to end the accumulation of the charges in the photoelectric conversion unit based on the comparison result, in which the reference voltage to be compared with the output voltage based on the charges transferred from the photoelectric conversion unit to the charge accumulation unit when the charge transfer unit is in a non-conductive state, is a voltage corresponding to charges accumulated in the charge accumulation unit due to a dark current.

Further features of the present invention will become apparent from the following description of exemplary embodiments with reference to the attached drawings.

### BRIEF DESCRIPTION OF THE DRAWINGS

FIG. 1 is a diagram for illustrating a circuit configuration of a photoelectric conversion apparatus according to a first embodiment of the present invention.

FIG. 2 is a cross-sectional view of a pixel according to the first embodiment.

FIG. 3 is a timing chart for illustrating operation of the photoelectric conversion apparatus according to the first embodiment.

FIGS. 4A, 4B, 4C, 4D, 4E, 4F and 4G are potential diagrams of a pixel according to the first embodiment.

FIGS. 5A, 5B, 5C and 5D are potential diagrams of pixels according to the first embodiment and a comparative example thereof.

FIG. 6 is a circuit layout diagram of a photoelectric conversion apparatus according to a second embodiment of the present invention.

FIG. 7 is a timing chart for illustrating operation of the photoelectric conversion apparatus according to the second embodiment.

FIGS. 8A, 8B, 8C and 8D are potential diagrams of pixels according to the second embodiment and a comparative example thereof.

FIG. 9 is a timing chart for illustrating operation of a photoelectric conversion apparatus according to a third embodiment of the present invention.

FIGS. 10A, 10B, 10C and 10D are potential diagrams of pixels according to the third embodiment and a comparative example thereof.

FIG. 11 is a circuit layout diagram of a photoelectric conversion apparatus according to a fourth embodiment of the present invention.

FIG. 12 is a diagram for illustrating a circuit configuration of the photoelectric conversion apparatus according to the fourth embodiment.

FIG. 13 is a block diagram for illustrating a configuration of an imaging system according to a fifth embodiment of the present invention.

### DESCRIPTION OF THE EMBODIMENTS

Preferred embodiments of the present invention will now be described in detail in accordance with the accompanying drawings.

### First Embodiment

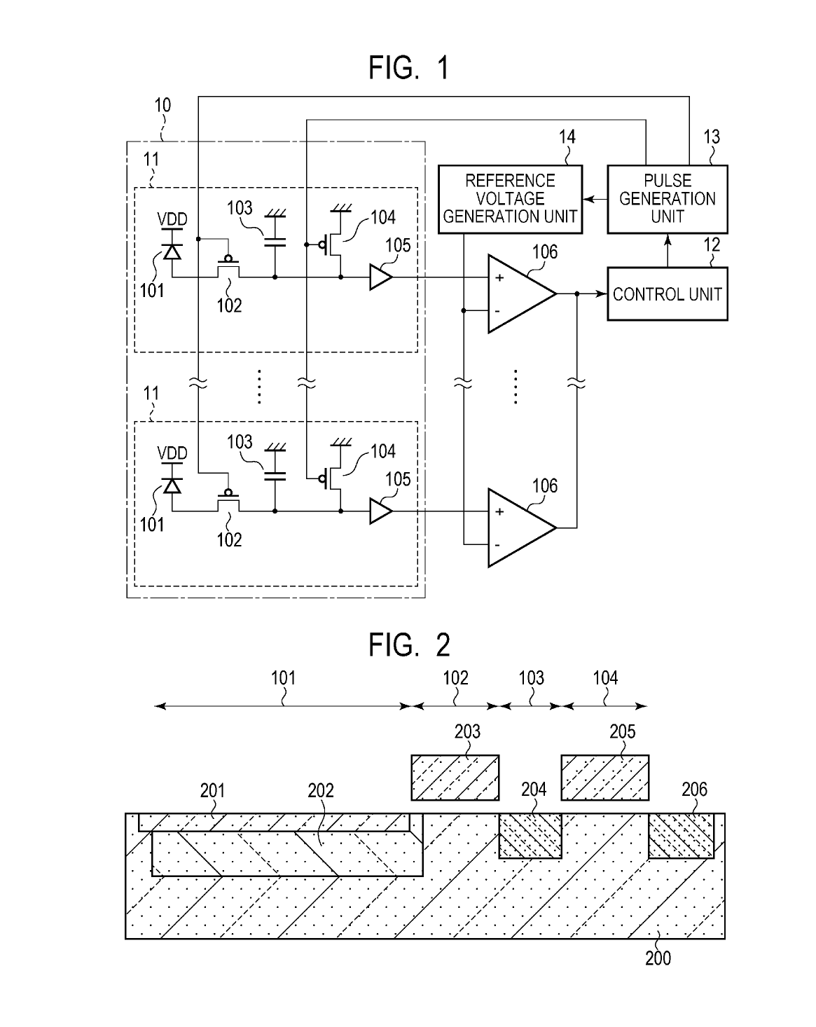

FIG. 1 is a diagram for illustrating an example of a circuit configuration of a photoelectric conversion apparatus according to a first embodiment of the present invention. The photoelectric conversion apparatus includes a pixel unit 10, a control unit 12, a pulse generation unit 13, a reference voltage generation unit 14, and a plurality of comparators (comparison units) 106. The pixel unit 10 includes a plurality of pixels 11. In this embodiment, the pixels 11 are arranged one-dimensionally, but the present invention is not limited thereto. Each of the pixels 11 includes a photoelectric conversion unit 101, a charge transfer unit 102, a floating diffusion (hereinafter referred to as “FD”) 103, a reset unit 104, and an amplification unit 105. Moreover, the plurality of comparators 106 are provided in correspondence with the plurality of pixels 11, respectively.

The photoelectric conversion unit 101 is formed of a photodiode having a cathode to which a power supply voltage VDD is input. The photoelectric conversion unit 101 is configured to generate and accumulate photocharges corresponding to incident light. In the case of this embodiment, the charges generated and accumulated in the photoelectric conversion unit 101 are holes, but the configuration may be modified to accumulate electrons.

Each of the charge transfer unit 102 and the reset unit 104 is formed of a p-type metal oxide semiconductor (PMOS) transistor. The charge transfer unit 102 is connected between an anode of the photoelectric conversion unit 101 and the FD 103. The charge transfer unit 102 is controlled to be in a conductive state (on) or a non-conductive state (off) in response to a transfer pulse input from the pulse generation unit 13, and is configured to transfer the charges generated in the photoelectric conversion unit 101 to the FD 103 (hereinafter referred to as “charge transfer operation”). Note that, each of the charge transfer unit 102 and the reset unit 104 may be formed of an n-type metal oxide semiconductor (NMOS) transistor. In this case, high and low of control signals to be described later are inverted to allow similar control.

When the charge transfer unit 102 is in the non-conductive state and when the number of charges accumulated in the photoelectric conversion unit 101 exceeds a saturation charge amount, excessive charges generated but cannot be accumulated in the photoelectric conversion unit 101 overflow from the photoelectric conversion unit 101, and move to the FD 103 via the charge transfer unit 102.

The FD 103 is capacitance formed at an input node of the amplification unit 105. The capacitance may be parasitic capacitance generated at the input node of the amplification unit 105, or may be formed by connecting a capacitive element. At the FD 103, a voltage corresponding to the charges transferred from the photoelectric conversion unit 101 is generated. This voltage is input to the amplification unit 105. In other words, the FD 103 serves as a charge accumulation unit, and also has a function of charge-voltage conversion.

The reset unit 104 has a source connected to the FD 103, and a drain to which a voltage corresponding to a predetermined reset voltage is input. This voltage may be a voltage supplied from a reset voltage source (not illustrated), or may be a ground voltage as illustrated in the figure. In response to a reset pulse input from the pulse generation unit 13 to a gate of the reset unit 104, the reset voltage is supplied to the FD 103. This resets the photoelectric conversion unit 101 and the FD 103 to the reset voltage (hereinafter referred to as “reset operation”).

The amplification unit 105 is formed of a source follower circuit or the like, and has a function of amplifying or buffering and outputting an input voltage. The amplification unit 105 has an output node connected to a non-inverting input terminal of the comparator 106.

The comparator 106 has the non-inverting input terminal, an inverting input terminal, and an output terminal. To the inverting input terminal of the comparator 106, a reference voltage is input from the reference voltage generation unit 14. The output terminal of the comparator 106 is connected to the control unit 12. The comparator 106 is configured to compare the reference voltage, which is input to the inverting input terminal, and an output voltage of the amplification unit 105, which is input to the non-inverting input terminal, and output a comparison result to the control unit 12. More specifically, a high voltage is output from the output terminal to the control unit 12 in a case where the output voltage of the amplification unit 105 is higher than the reference voltage, and a low voltage is output otherwise.

The comparator 106 may have an offset voltage between the input terminals. In this case, the high voltage is output from the output terminal to the control unit 12 in a case where a difference between the output voltage of the amplification unit 105 and the reference voltage is higher than the offset voltage, and the low voltage is output otherwise.

The output node of the amplification unit 105 may be connected to the inverting input terminal of the comparator 106, and the reference voltage generation unit 14 may be connected to the non-inverting input terminal of the comparator 106. This case is similar to the above-mentioned case, except that the high and low output voltages are inverted.

The control unit 12 is configured to monitor the voltage input from the comparator 106, determine an overflow of the excessive charges from the photoelectric conversion unit 101 to the FD 103 based on a change of the voltage, and control a timing to end the accumulation of the charges in the photoelectric conversion unit 101. This processing is described later. Moreover, the control unit 12 is configured to transmit, based on a signal from a timing generation unit (not illustrated), a control signal for instructing timings to output the reset pulse and the transfer pulse, to the pulse generation unit 13. As described above, the reset pulse and the transfer pulse serve as triggers for the reset operation and the charge transfer operation of the pixel 11, respectively. The control unit 12 is configured to output a pulse for the reset operation at a predetermined timing. Moreover, the control unit 12 is configured to output a pulse for the charge transfer operation at a timing corresponding to the signal input from the timing generation unit and the signal input from the comparator 106.

The pulse generation unit 13 is connected to gates of the charge transfer unit 102 and the reset unit 104. The pulse generation unit 13 is configured to output the transfer pulse and the reset pulse in accordance with the control signal input from the control unit 12. The transfer pulse is input to each of the charge transfer units 102 of the plurality of pixels 11 to control operations of the plurality of charge transfer units 102 at the same time. The reset pulse is input to each of the reset units 104 of the plurality of pixels 11 to control operations of the reset units 104 at the same time. Moreover, the pulse generation unit 13 is configured to supply a control signal for instructing a timing to start outputting the reference voltage, to the reference voltage generation unit 14.

The reference voltage generation unit 14 is configured to generate and output the reference voltage based on the instruction of the control signal from the pulse generation unit 13. In this embodiment, the reference voltage generation unit 14 is configured to generate the reference voltage by a voltage source (not illustrated). The reference voltage output by the reference voltage generation unit 14 is set based on a voltage generated by the charges accumulated in the FD 103 due to a dark current. For example, an output voltage of the voltage source is set to be changed with respect to accumulation time of the charges in the photoelectric conversion unit. Moreover, a rate of change (slope) of the output voltage with respect to the accumulation time may be set based on a rate of change in voltage, which is caused by the dark current generated in the FD 103 and is measured in advance. The rate of change of the output voltage may be set based not on the actual measurement data of the voltage caused by the dark current, but on a simulated rate of change in voltage caused by the dark current.

FIG. 2 is a cross-sectional view of the photoelectric conversion unit 101, the charge transfer unit 102, the FD 103, and the reset unit 104 in the pixel 11 of FIG. 1. In a semiconductor substrate including the photoelectric conversion apparatus, first conductivity type semiconductor regions 200 and 201 and second conductivity type semiconductor regions 202, 204, and 206 are formed. Moreover, over the semiconductor substrate, electrodes 203 and 205, which are gate electrodes of the PMOS, are formed on an insulating layer (not illustrated), which is interposed between the semiconductor substrate and the electrodes 203 and 205.

The photoelectric conversion unit 101 is formed of the first conductivity type semiconductor region 201 and the second conductivity type semiconductor region 202. The first conductivity type semiconductor region 201 is formed on a surface of the second conductivity type semiconductor region 202. In this manner, an effect of suppressing the dark current due to a defect that is present on a surface of the semiconductor substrate is obtained. The second conductivity type semiconductor region 202 is formed in the first conductivity type semiconductor region 200 to form a pn junction. This junction causes the photocharges generated in accordance with the light irradiated on the photoelectric conversion unit 101 to be accumulated in the second conductivity type semiconductor region 202.

The electrode 203 forming the charge transfer unit 102 is formed between the second conductivity type semiconductor region 202 and the second conductivity type semiconductor region 204. Moreover, the second conductivity type semiconductor region 204 forms the FD 103. When a predetermined voltage is applied to the electrode 203, a channel is formed at a surface of the semiconductor immediately below the electrode 203, and the photocharges accumulated in the photoelectric conversion unit 101 are transferred to the FD 103. The electrode 205 forming the reset unit 104 is formed between the second conductivity type semiconductor region 204 and the second conductivity type semiconductor region 206. When a predetermined voltage is applied to the electrode 205, a channel is formed at a surface of the semiconductor immediately below the electrode 205, and the charges accumulated in the FD 103 are discharged to the second conductivity type semiconductor region 206.

In the case of the circuit illustrated in FIG. 1 in this embodiment, the first conductivity type is an n type, and the second conductivity type is a p type. However, the configuration may be modified so that the first conductivity type is the p type, and the second conductivity type is the n type. In this case, each of the charge transfer unit 102 and the reset unit 104 is made of an NMOS transistor, and the anode and the cathode of the photoelectric conversion unit 101 illustrated in FIG. 1 are reversed.

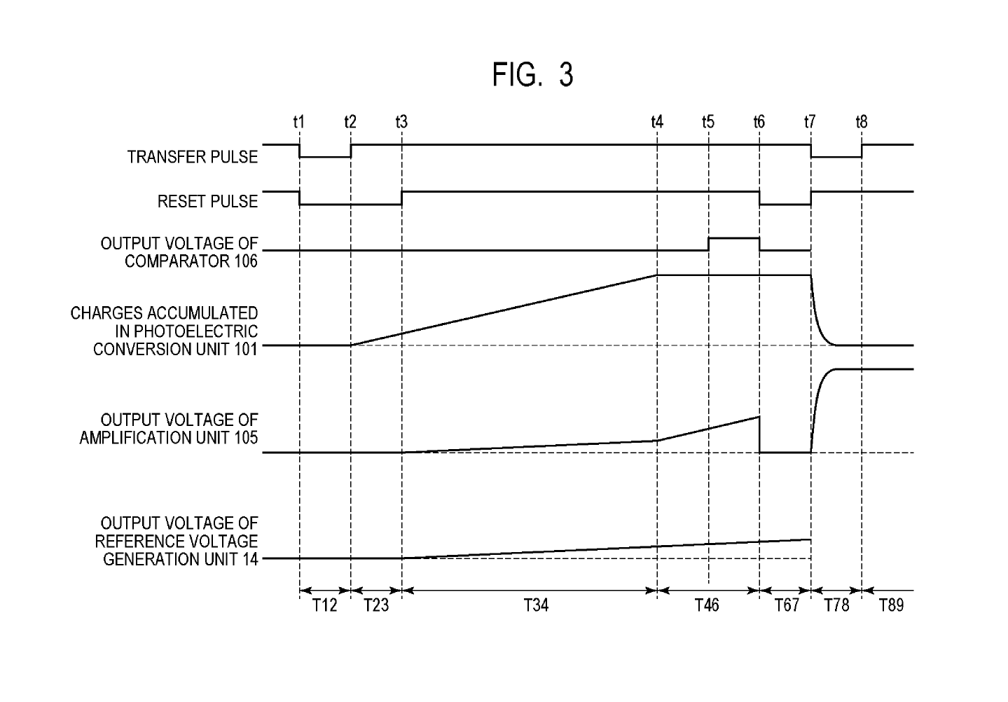

FIG. 3 is a timing chart for illustrating relationships of respective pulses, output voltages, and the like of the photoelectric conversion apparatus according to the first embodiment. The transfer pulse and the reset pulse are control signals input to the PMOS transistor, and hence illustrated to be low active. In other words, in periods in which the transfer pulse and the reset pulse are low, the charge transfer unit 102 and the reset unit 104 are in conductive states, respectively.

Period T12 is a reset period for the photoelectric conversion unit 101 and the FD 103, and time t1 is a start time of the reset operation. At time t1, the transfer pulse and the reset pulse become low. This causes the charges accumulated in the photoelectric conversion unit 101 and the FD 103 to be discharged. Note that, at this time, the output voltage of the amplification unit 105 becomes a voltage corresponding to the reset voltage. Moreover, an output voltage of the reference voltage generation unit 14 is set to a value that is higher than the output voltage of the amplification unit 105. This makes an output voltage of the comparator 106 low.

Time t2 is a time at which the photocharges start to be accumulated in the photoelectric conversion unit 101. At time t2, the transfer pulse becomes high. As a result, the charge transfer unit 102 enters the non-conductive state, and the photoelectric conversion unit 101 ends discharging the charges. At the same time, the accumulation of the photocharges is started, and an amount of charges accumulated in the photoelectric conversion unit 101 starts to increase. The amount of charges generated in the photoelectric conversion unit 101 is prounital to exposure time. Therefore, as illustrated in FIG. 3, the amount of charges generated in the photoelectric conversion unit 101 is linear with respect to the accumulation time.

Time t3 is a time at which overflow detection of the excessive charges to the FD 103 is started. In the following Periods T34 and T46, the overflow detection of the excessive charges is performed. At time t3, the reset pulse becomes high and hence the reset unit 104 enters a non-conductive state, and the FD 103 ends discharging the charges. At the same time, the charges are accumulated in the FD 103 due to the dark current generated in the FD 103. As a result, a potential of the FD 103 and the output voltage of the amplification unit 105 start to increase. The amount of charges generated due to the dark current is prounital to elapsed time of the charge accumulation. Therefore, as illustrated in FIG. 3, the output voltage of the amplification unit 105 is also linear with respect to the elapsed time of the charge accumulation.

At the same time, the reference voltage is input to the inverting input terminal of the comparator 106 by the reference voltage generation unit 14. The reference voltage is set based on the charges accumulated due to the dark current generated in the FD 103. Therefore, it is preferred that the reference voltage be linear with respect to the elapsed time of the charge accumulation. The slope of the change in reference voltage with respect to the accumulation time is defined to correspond to the slope of the change with time of the output voltage of the amplification unit, which is generated by the charges accumulated in the FD 103 due to the dark current. In this manner, the change in output voltage due to the dark current may be compensated for, and the effect of the dark current is reduced. At this time, it is more preferred that both of the slopes be identical. In this manner, the effect of the dark current is further reduced.

Time t4 is a time at which overflow starts. At time t4, the charges accumulated in the photoelectric conversion unit 101 exceed the saturation charge amount that can be accumulated. The excessive charges generated in the photoelectric conversion unit 101 but cannot be accumulated overflow to the FD 103 via the charge transfer unit 102. As a result, in periods T46 and T67 after time t4, the amount of charges accumulated in the photoelectric conversion unit 101 becomes constant at the saturation charge amount. The excessive charges that have overflowed are accumulated in the FD 103, and hence in period T46 from time t4 to time t6, the slope of the increase in potential of the FD 103 is increased. Therefore, the slope of the output voltage of the amplification unit 105 is also increased.

Time t5 is a time at which the overflow is detected. When the output voltage of the amplification unit 105 exceeds the reference voltage due to the excessive charges accumulated in the FD 103 due to the overflow, the output voltage of the comparator 106 changes from low to high. When the control unit 12 detects this change in output voltage and determines that a predetermined amount of overflow has occurred, the control unit 12 transmits a control signal to the pulse generation unit 13 to control the timing to end the accumulation of the charges in the photoelectric conversion unit 101, and hence to control a charge accumulation amount. As an example of this control, with the determination of the control unit 12 that the predetermined amount of overflow has occurred as a trigger, resetting at time t6 and transfer at time t7, which are to be described later, may be started. In this manner, at a time point when an accumulation amount of charges has become an appropriate amount, a control may be performed to output signals accumulated in the photoelectric conversion unit 101. With this control, in a case where the photoelectric conversion apparatus according to this embodiment is used as a focus position detection apparatus, for example, a signal of a level that is appropriate for an autofocus operation may be obtained automatically depending on a luminance of a scene to be photographed.

Time t6 is a time to start resetting the FD before transferring the charges, and period T67 is an FD reset period. At time t6, the reset pulse becomes low, and hence the reset unit 104 enters the conductive state. With this operation, the charges and the excessive charges accumulated in the FD 103 due to the dark current are discharged, and the output of the amplification unit 105 returns to the voltage corresponding to the reset voltage.

Time t7 is a time to start transferring the charges, and period T78 is a charge transfer period. At time t7, the reset pulse becomes high, and the transfer pulse becomes low. As a result, the reset unit 104 enters the non-conductive state, and the discharge of the charges from the FD 103 ends. Meanwhile, the charge transfer unit 102 enters the conductive state, and the photocharges accumulated in the photoelectric conversion unit 101 are transferred to the FD 103. With this operation, the amount of charges accumulated in the photoelectric conversion unit 101 is decreased, and the output voltage of the amplification unit 105 is increased to correspond to an amount of photocharges. Note that, the comparator 106 is not used in operation after time t7, and hence the output voltage of the comparator 106 and the output voltage of the reference voltage generation unit 14 are not illustrated in the figure.

Period T89 after time t8 is a signal readout period. The output voltage of the amplification unit 105 based on the amount of photocharges that have transferred to the FD 103 is output to an outside of the photoelectric conversion apparatus via an output amplifier (not illustrated). This output voltage may be used as a luminance signal for focus detection and the like.

In this embodiment, the excessive charges are used for the overflow detection, and hence the overflow is detected at time t5, which is before time t7 at which the photocharges are transferred from the photoelectric conversion unit 101. Therefore, there is no need to read out the photocharges accumulated in the photoelectric conversion unit 101 for the purpose of overflow detection, and both the control of the accumulation amount and accumulation of sufficient charges may be realized. Moreover, in this control, the change in output voltage due to the dark current is compensated for, and hence the effect of the dark current generated in the FD 103 is reduced.

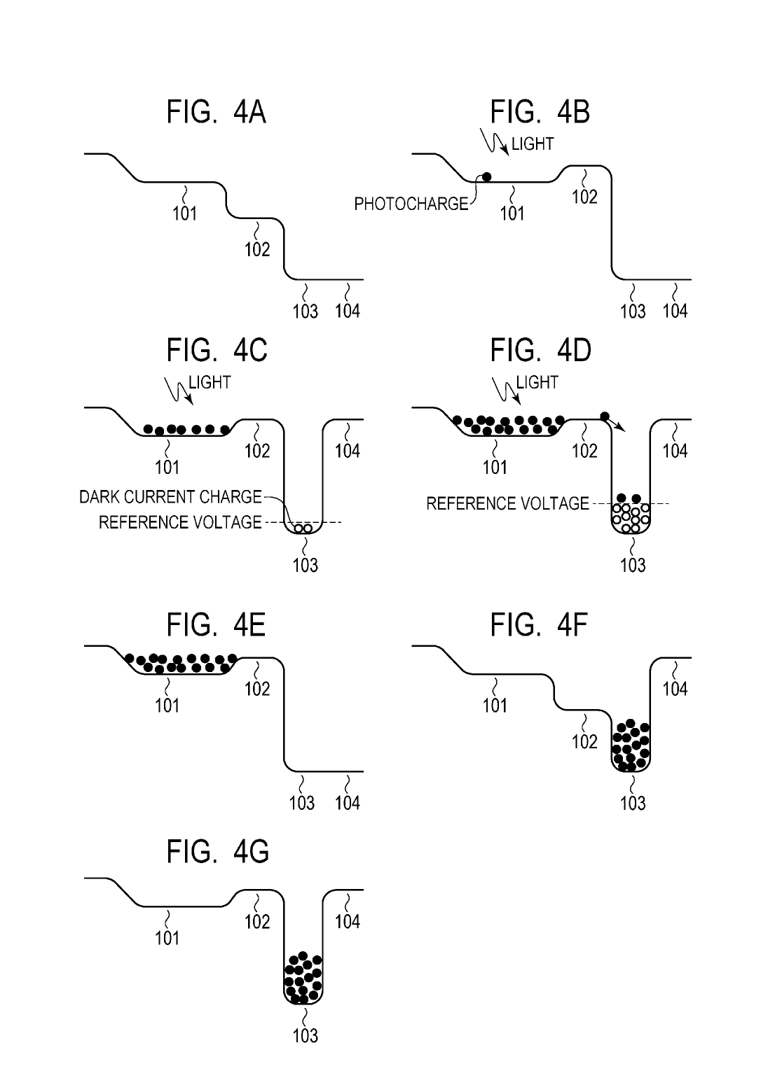

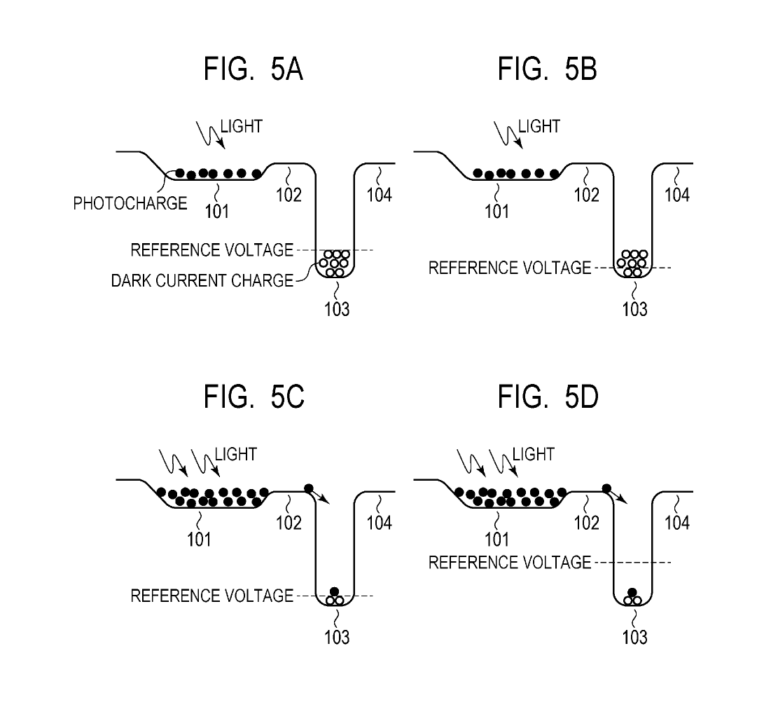

A principle by which the effect of the dark current generated in the FD 103 is reduced with the above-mentioned operation timings is described in greater detail with reference to FIG. 4A to FIG. 4G and FIG. 5A to FIG. 5D. FIG. 4A to FIG. 4G are potential diagrams for illustrating relationships of potentials of the photoelectric conversion unit 101, the charge transfer unit 102, the FD 103, and the reset unit 104 in FIG. 3 and the charges.

FIG. 4A is a potential diagram in period T12. In period T12, each of the charge transfer unit 102 and the reset unit 104 is in the conductive state. Therefore, the charges generated in the photoelectric conversion unit 101 are discharged via the charge transfer unit 102 and the reset unit 104, and hence the charges are not accumulated in the photoelectric conversion unit 101 and the FD 103.

FIG. 4B is a potential diagram in period T23. The black circle in the figure indicates a photocharge generated by light. At time t2, the charge transfer unit 102 enters the non-conductive state, and hence the photocharges generated in the photoelectric conversion unit 101 start to be accumulated in the photoelectric conversion unit 101. At this time, the reset unit 104 is maintained in the conductive state.

FIG. 4C is a potential diagram in period T34. In order to distinguish from the photocharges, the charges generated by the dark current are indicated by the white circles. The broken line illustrated in the FD 103 in the figure indicates a potential corresponding to the reference voltage, which is input to the inverting input terminal of the comparator 106. At time t3, the reset unit 104 enters the non-conductive state, and the charges (dark current charges) caused by the dark current generated in the FD 103 start to be accumulated in the FD 103. As described above, the reference voltage is a voltage that changes with the elapsed time based on the dark current generated in the FD 103. As the dark current charges increase with the elapsed time, the reference voltage is also increased, and hence the possibility that the control unit 12 erroneously determines that the overflow has occurred due to the charges resulting from the dark current is reduced. In the photoelectric conversion unit 101, with the accumulation of the charges, a larger number of charges than that at the time point in period T23 are accumulated.

FIG. 4D is a potential diagram in period T46. In period T46, the photocharges are accumulated to saturate the photoelectric conversion unit 101, and the photocharges overflow to the FD 103 via a potential of the charge transfer unit 102. The excessive charges are added to the FD 103 to increase the potential of the FD 103, and the potential of the FD 103 exceeds the reference voltage. As a result, the output voltage of the comparator 106 is inverted from low to high. Based on this change in voltage, the control unit 12 determines that the overflow has occurred.

FIG. 4E is a potential diagram in period T67. The reset unit 104 enters the conductive state, and the dark current charges and the excessive charges, which have been accumulated in the FD 103, are discharged.

FIG. 4F is a potential diagram in period T78. The reset unit 104 enters the non-conductive state, and the charge transfer unit 102 enters the conductive state. With this operation, the photocharges accumulated in the photoelectric conversion unit 101 are transferred to the FD 103, which has been reset.

FIG. 4G is a potential diagram in period T89. The charge transfer unit 102 enters the non-conductive state, and the potential of the FD 103 takes a value corresponding to the transferred photocharges. The output voltage of the amplification unit 105 at this time is read out as an output signal of the photoelectric conversion apparatus.

FIG. 5A to FIG. 5D are potential diagrams of pixels according to this embodiment and a comparative example of this embodiment. FIG. 5A is a diagram for illustrating a relationship between the dark current charges and the reference voltage in this embodiment under low luminance, and FIG. 5B is a diagram for illustrating a relationship between the dark current charges and the reference voltage under low luminance and in a case where the reference voltage is set low as the comparative example.

In this embodiment, the reference voltage has a value set based on the charges resulting from the dark current, and hence even when the increase in potential of the FD 103 occurs due to the dark current as illustrated in FIG. 5A, the potential may be prevented from exceeding the reference voltage.

On the other hand, in FIG. 5B according to the comparative example, the reference voltage is set low, and hence the potential of the FD 103 may be increased due to the dark current to exceed the reference voltage. In this case, the output voltage of the comparator 106 is inverted from low to high, and hence the control unit 12 erroneously determines that the overflow has occurred. As a result, a transfer operation is started to read out a signal even though sufficient photocharges are not accumulated in the photoelectric conversion unit 101. Therefore, in a case where such a photoelectric conversion apparatus according to the comparative example is used as the focus position detection apparatus, the output signal may become small, and hence an autofocus accuracy may be reduced.

FIG. 5C is a diagram for illustrating a relationship between the dark current charges and the reference voltage in this embodiment under high luminance, and FIG. 5D is a diagram for illustrating a relationship between the dark current charges and the reference voltage under high luminance and in a case where the reference voltage is set high as the comparative example.

In this embodiment illustrated in FIG. 5C, the reference voltage has a value set based on the dark current, and hence even in a photography scene in which the overflow tends to occur under high luminance as illustrated in FIG. 5C, the overflow may be detected.

On the other hand, in FIG. 5D according to the comparative example, the reference voltage is set high, and hence the overflow is not detected in a short period of time. As a result, in the comparative example, charge accumulation time is long, and the overflow may occur in a large number of pixels. Therefore, in a case where such a photoelectric conversion apparatus according to the comparative example is used as the focus position detection apparatus, the number of pixels in which an accuracy of the output signal is reduced due to the overflow may be large, and hence the autofocus accuracy may be reduced.

According to the photoelectric conversion apparatus in this embodiment, the reference voltage input to the comparator 106 is a voltage based on the charges accumulated by the dark current generated in the FD 103. Therefore, the overflow may be accurately detected in both photography scenes under low luminance and under high luminance. Such a photoelectric conversion apparatus is used for the focus position detection apparatus to further improve the autofocus accuracy.

### Second Embodiment

A second embodiment of the present invention is described. In this embodiment, a configuration in which, in a case where a photoelectric conversion apparatus includes a plurality of pixel units, the reference voltage input to the comparator of each of the pixel units is different is adopted. A description on components similar to those of the first embodiment is omitted.

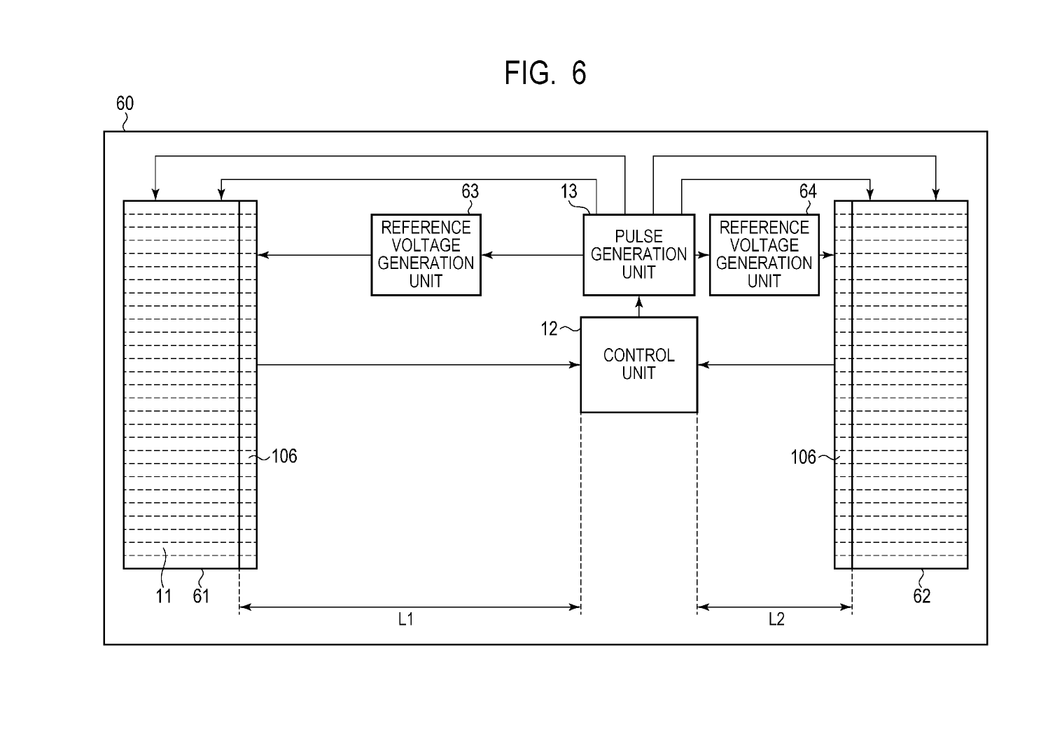

FIG. 6 is a diagram for illustrating an example of a circuit layout of the photoelectric conversion apparatus according to the second embodiment. A photoelectric conversion apparatus 60 includes pixel units 61 and 62, the comparator 106, the control unit 12, the pulse generation unit 13, and reference voltage generation units 63 and 64. Moreover, each of the pixel unit 61 and the pixel unit 62 includes a plurality of pixels 11 arranged one-dimensionally. The reference voltage generation unit 63 is configured to supply a first reference voltage to the comparators 106 connected to the pixel unit 61, and the reference voltage generation unit 64 is configured to supply a second reference voltage to the comparators 106 connected to the pixel unit 62. The control unit 12 and the pulse generation unit 13 may individually control the pixel units 61 and 62 and the reference voltage generation units 63 and 64. In other words, the transfer pulse and the reset pulse may be supplied to the respective pixel units at different operation timings. Moreover, the reference voltage generation units 63 and 64 may supply mutually different reference voltages.

A distance from the control unit 12 and the pulse generation unit 13 to the pixel unit 61 is represented by L1, and a distance from the control unit 12 and the pulse generation unit 13 to the pixel unit 62 is represented by L2. In this example, as illustrated in FIG. 6, the circuit layout in this embodiment has a relationship: L1>L2. In this case, the pixel unit 62 is close to the control unit 12 and the pulse generation unit 13, and hence is likely to be affected by heat generation resulting from power consumption in the control unit 12 and the pulse generation unit 13. As the temperature becomes higher, an amount of generation of the dark current becomes larger, and hence the dark current generated in the pixel unit 62 is larger than the dark current generated in the pixel unit 61.

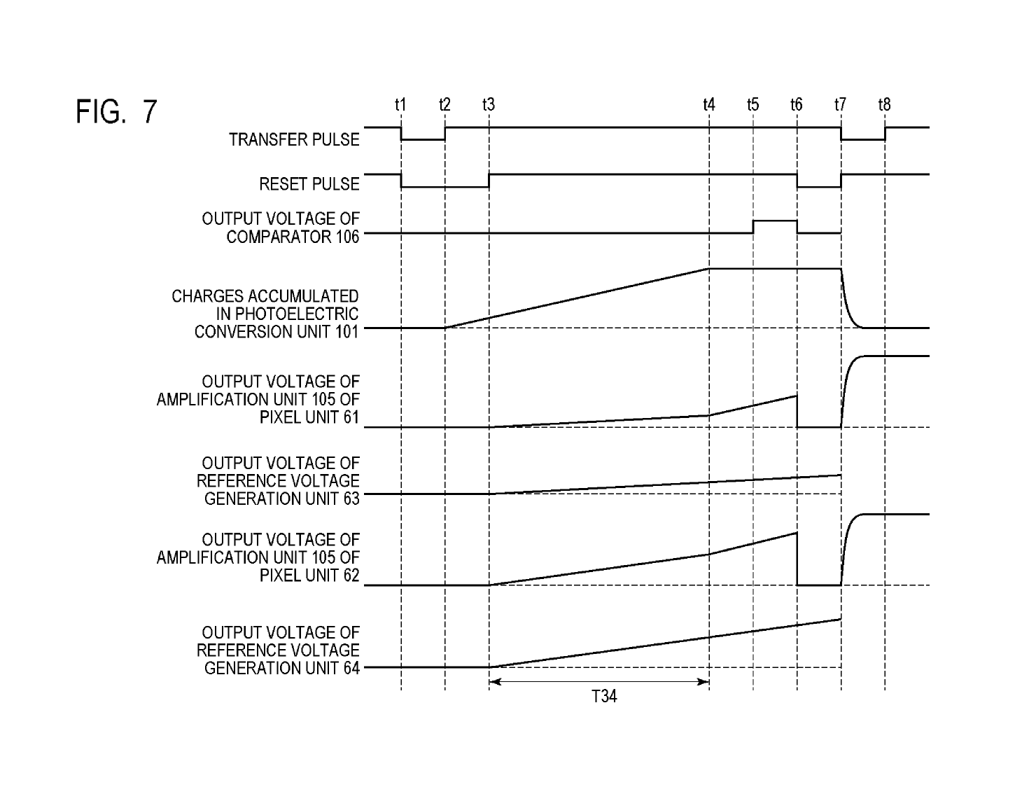

FIG. 7 is a timing chart for illustrating relationships of respective pulses, output voltages, and the like of the photoelectric conversion apparatus according to the second embodiment. The same times and periods are denoted by the same reference symbols as those of FIG. 3. It is assumed that the same amount of light is irradiated on the pixel unit 61 and the pixel unit 62. This timing chart is different from FIG. 3 in that the reference voltages input to the reference voltage generation units 63 and 64 in period T34 are different. In the pixel unit 61, the distance L1 to the control unit 12 and the pulse generation unit 13 is large, with the result that the generated dark current is small, and that the slope of the output voltage of the amplification unit 105 in period T34 is small. Therefore, the reference voltage input to the pixel unit 61 is also set to have a correspondingly small slope. On the other hand, in the pixel unit 62, the distance L2 to the control unit 12 and the pulse generation unit 13 is small, with the result that the dark current is large, and that the slope of the output voltage of the amplification unit 105 in period T34 is large. Therefore, the reference voltage input to the pixel unit 62 is also set to have a correspondingly large slope.

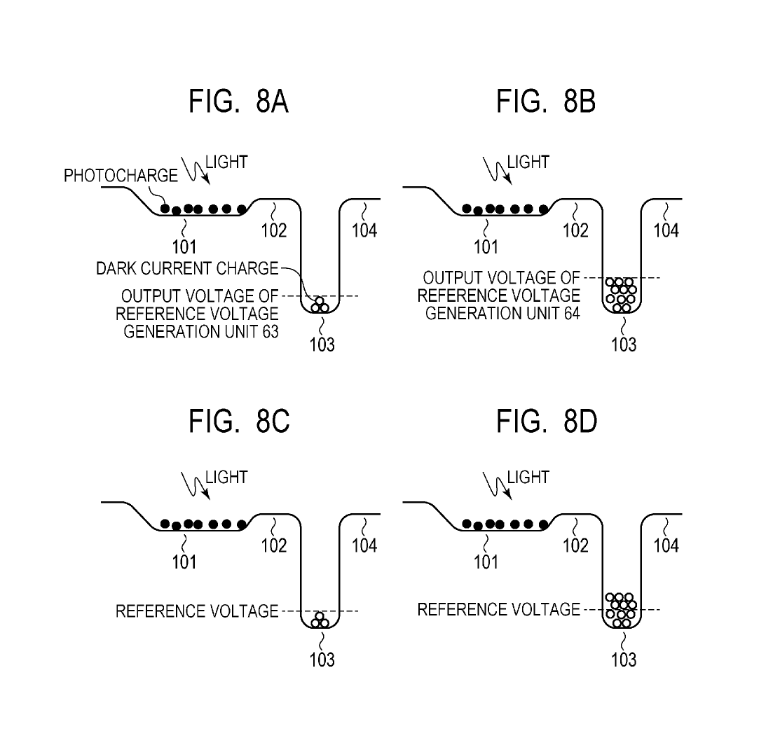

FIG. 8A to FIG. 8D are potential diagrams for illustrating effects of the second embodiment. FIG. 8A is a potential diagram for illustrating a relationship of the potentials of the photoelectric conversion unit 101, the charge transfer unit 102, the FD 103, and the reset unit 104 included in the pixel unit 61 and the charges. FIG. 8B is a potential diagram relating to the pixel unit 62. In FIG. 8A, the distance L1 from the pixel unit 61 to the control unit 12 and the pulse generation unit 13 is large, and hence the number of dark current charges is small. The reference voltage is set low accordingly. On the other hand, in FIG. 8B, the distance L2 from the pixel unit 62 to the control unit 12 and the pulse generation unit 13 is small, and hence the number of dark current charges is large. The reference voltage is set high accordingly. In both of the pixel units, the reference voltages are set to correspond to the dark current, and hence there is little possibility that the dark current charges are erroneously determined as the excessive charges.

In contrast, in FIG. 8C and FIG. 8D, as comparative examples of this embodiment, potential diagrams in a case where the reference voltages for the pixel units 61 and 62 are set to the same value are illustrated. FIG. 8C is a potential diagram relating to the pixel unit 61. In the case where the reference voltages are set to correspond to the dark current generated in the FD 103 of the pixel unit 61, as in the case of FIG. 8A, there is little possibility in the pixel unit 61 that the dark current charges are erroneously determined as the excessive charges. However, in a potential diagram relating to the pixel unit 62 of FIG. 8D, the output voltage that has increased due to the dark current charges exceeds the reference voltage set to the same value as that for the pixel unit 61. In this case, the increase in potential due to the dark current charges may be erroneously determined as the overflow.

According to the configuration in this embodiment, in the case where the photoelectric conversion apparatus includes the plurality of pixel units, the configuration in which the reference voltage input to the comparator of each of the pixel units is different is adopted. As a result, degradation in accuracy of the overflow detection due to a difference in amount of generation of the dark current caused by a difference between the distances from the pixel units to the control unit 12 and the pulse generation unit 13 is reduced. Such a photoelectric conversion apparatus is used for the focus position detection apparatus to improve the autofocus accuracy.

### Third Embodiment

A third embodiment of the present invention is described. In this embodiment, a configuration in which the reference voltage is changed depending on a temperature of a photoelectric conversion apparatus is adopted. A circuit configuration is similar to that of the first embodiment illustrated in FIG. 1, and hence a description thereof is omitted.

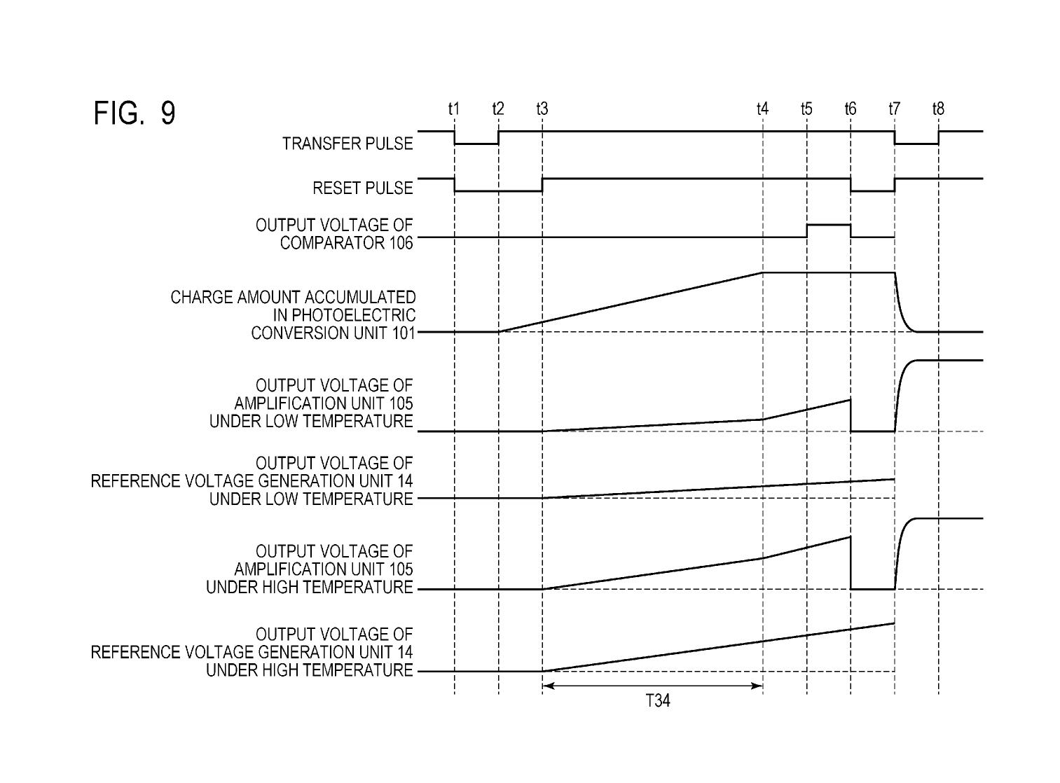

FIG. 9 is a timing chart for illustrating relationships of respective pulses, output voltages, and the like of the photoelectric conversion apparatus according to the third embodiment. The same times and periods are denoted by the same reference symbols as those of FIG. 3. This timing chart is different from FIG. 3 in that, in period T34, depending on the temperature of the photoelectric conversion apparatus, the output of the amplification unit 105 and the output voltage of the reference voltage generation unit 14 are different. For a reason similar to that described in the second embodiment, the dark current becomes larger as the temperature of the photoelectric conversion apparatus becomes higher. In a case where the temperature of the photoelectric conversion apparatus is low, the dark current generated in the FD 103 is small. Therefore, the slope of the output voltage of the amplification unit 105 in period T34 becomes small, and the reference voltage output from the reference voltage generation unit 14 is also set to have a correspondingly small slope. On the other hand, in a case where the temperature of the photoelectric conversion apparatus is high, the dark current generated in the FD 103 is large. Therefore, the slope of the output voltage of the amplification unit 105 in period T34 becomes large, and the reference voltage output from the reference voltage generation unit 14 is also set to have a correspondingly large slope.

Note that, the temperature of the photoelectric conversion apparatus may be obtained by providing a temperature sensor in the photoelectric conversion apparatus. In this manner, based on temperature information obtained from the temperature sensor, the reference voltage generation unit 14 may change the slope of the reference voltage to be output. For the above-mentioned reason, it is preferred that the slope of the reference voltage be set so that as the temperature becomes higher, the slope becomes larger. A relationship between the temperature and the slope of the reference voltage, which is used in this setting, may be measured in advance, or may be calculated by simulation.

The dark current depends on a temperature of the FD 103 in the pixel unit 10, in particular, and hence it is preferred to provide the above-mentioned temperature sensor at a position that is as close to the pixel unit 10 as possible. However, the temperature sensor does not necessarily need to be provided in the photoelectric conversion apparatus, and may be provided in any place in an imaging system such as a camera in which the photoelectric conversion apparatus is placed, for example.

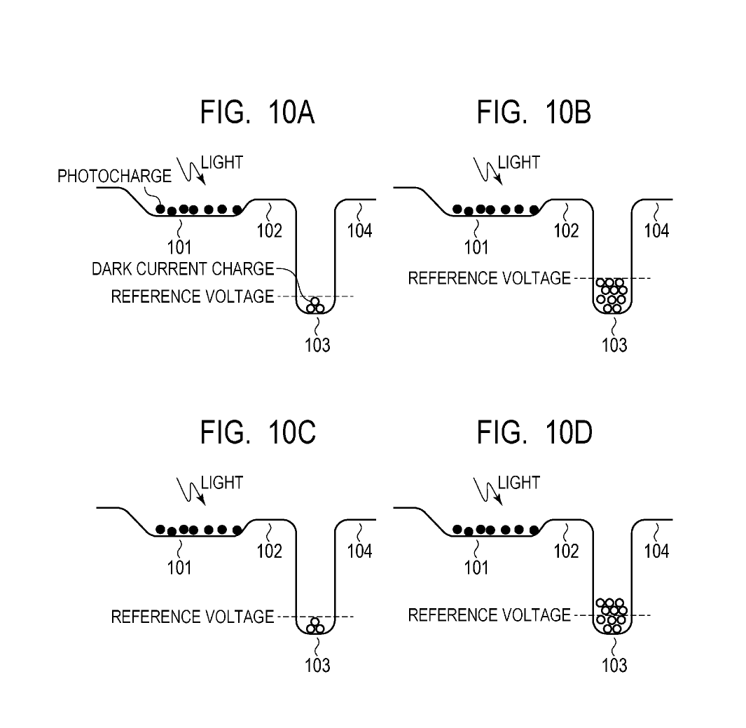

FIG. 10A to FIG. 10D are potential diagrams for illustrating effects of the third embodiment. FIG. 10A is a potential diagram for illustrating a relationship of the potentials of the photoelectric conversion unit 101, the charge transfer unit 102, the FD 103, and the reset unit 104 and the charges in a case where the temperature is low. FIG. 10B is a potential diagram relating to the pixel unit 62 in a case where the temperature is high.

In FIG. 10A, the temperature of the photoelectric conversion apparatus is low, and hence the number of dark current charges is small. The reference voltage is set low accordingly. On the other hand, in FIG. 10B, the temperature of the photoelectric conversion apparatus is high, and hence the number of dark current charges is large. The reference voltage is set high accordingly. In both of the temperatures, the reference voltage is set to correspond to the dark current, and hence there is little possibility that the dark current charges are erroneously determined as the excessive charges.

In contrast, in FIG. 10C and FIG. 10D, as comparative examples of this embodiment, potential diagrams in a case where the reference voltage is set to the same value irrespective of the temperature are illustrated. FIG. 10C is a potential diagram in a case where the temperature is low. In the case where the reference voltage is set to correspond to the dark current generated in the FD 103 of the pixel unit 10, as in the case of FIG. 10A, there is little possibility that the dark current charges are erroneously determined as the excessive charges. However, in a potential diagram of FIG. 10D in a case where the temperature is high, the output voltage that has increased due to the dark current charges exceeds the reference voltage set to the same value as that in a case where the temperature is low. In this case, the increase in potential due to the dark current charges may be erroneously determined as the overflow.

According to the configuration in this embodiment, the reference voltage input to the comparator of the pixel unit may be changed depending on the temperature of the photoelectric conversion apparatus. In this manner, the degradation in accuracy of the overflow detection due to the difference in amount of generation of the dark current caused by a change in temperature of an installation environment of the photoelectric conversion apparatus and a change in temperature such as heat generation of a peripheral device or the like is reduced. Such a photoelectric conversion apparatus is used for the focus position detection apparatus to further improve the autofocus accuracy.

### Fourth Embodiment

A fourth embodiment of the present invention is described. A pixel unit in this embodiment includes an optical black pixel (hereinafter referred to as “OB pixel”), in which the photoelectric conversion unit is shielded from light, and pixels (valid pixels), in which the photoelectric conversion unit is not shielded from light. This embodiment is different from the first to third embodiments in that an output voltage of the OB pixel is used as the reference voltage input to the comparator 106.

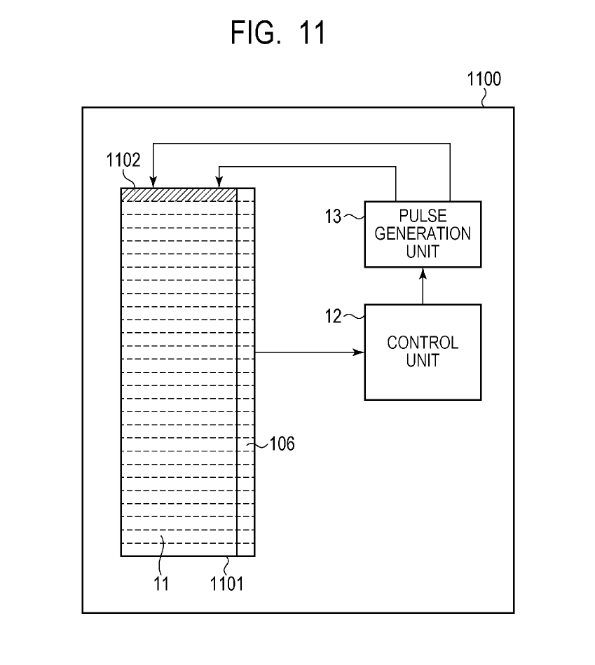

FIG. 11 is a diagram for illustrating an example of a circuit layout of a photoelectric conversion apparatus according to the fourth embodiment. A photoelectric conversion apparatus 1100 includes a pixel unit 1101, the control unit 12, the pulse generation unit 13, and the comparator 106. The pixel unit 1101 includes a plurality of pixels (valid pixels) 11 arranged one-dimensionally and an OB pixel 1102. At least one of the valid pixels 11 and the OB pixel 1102 are adjacent to each other. In the figure, only one OB pixel 1102 is illustrated, but a plurality of OB pixels 1102 may be included in the pixel unit 1101.

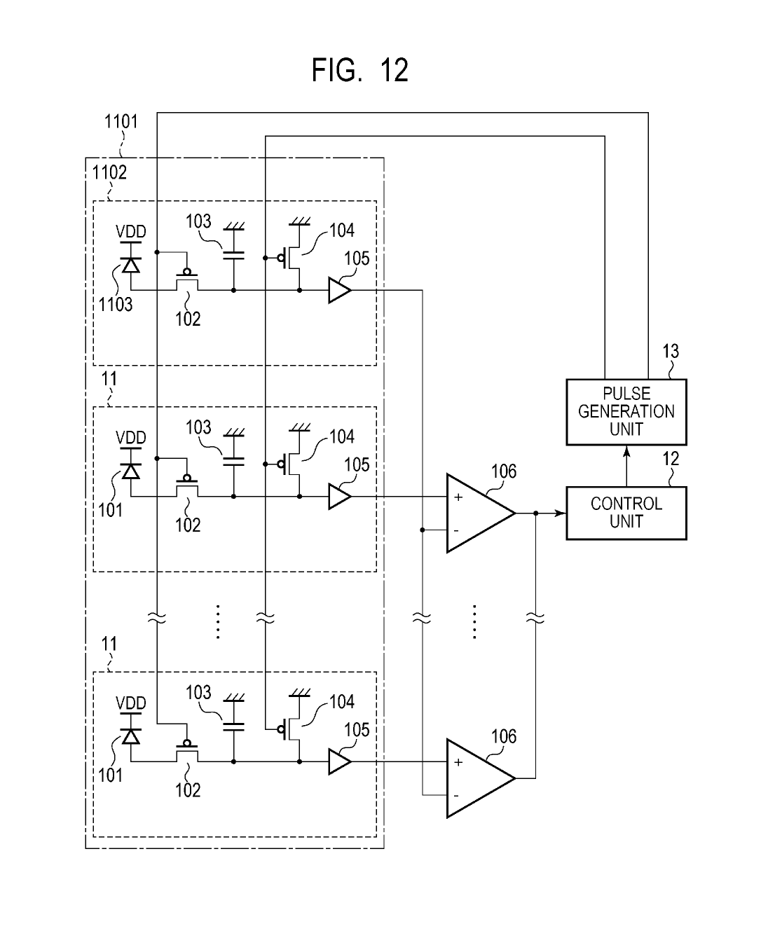

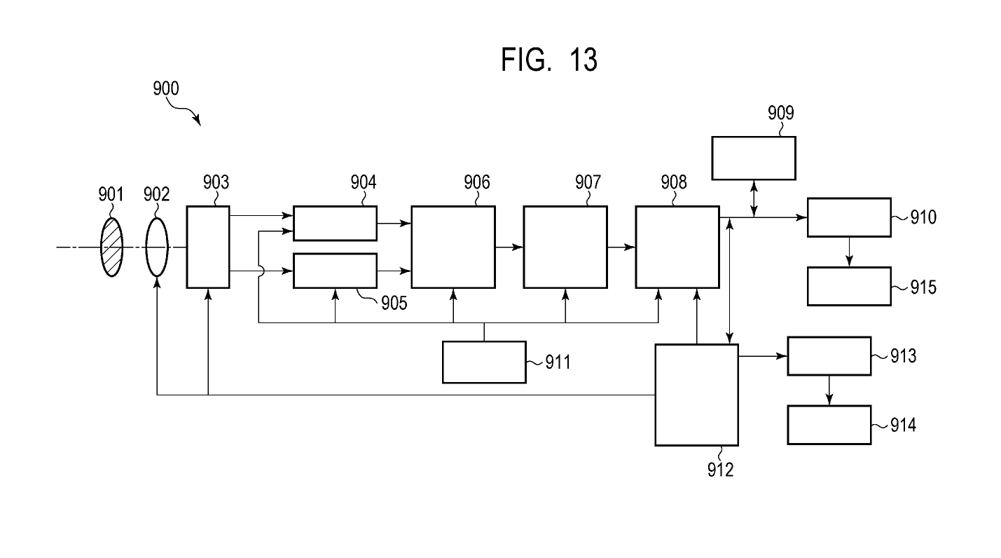

FIG. 12 is a diagram for illustrating an example of a circuit configuration of the photoelectric conversion apparatus according to the fourth embodiment. The same components are denoted by the same reference symbols as those of FIG. 1. The OB pixel 1102 includes a photoelectric conversion unit 1103, the charge transfer unit 102, the FD 103, the reset unit 104, and the amplification unit 105. The output voltage of the amplification unit 105 is connected to the inverting input terminal of the comparator 106 provided for each of the pixels 11. The OB pixel 1102 and the pixels 11 are driven by the same transfer pulse and reset pulse. The photoelectric conversion unit 1103 is configured so that the photodiode is covered with a material that hardly transmits light, such as a metal, and so that the light does not enter the photodiode.

The photoelectric conversion unit 1103 of the OB pixel 1102 is shielded from light, with the result that the photocharges are not generated, and hence the overflow does not occur. Therefore, the output voltage of the amplification unit 105 is a voltage corresponding to the dark current charges accumulated in the FD 103. Moreover, the OB pixel 1102 is adjacent to the pixels 11, and hence the effect of the dark current, which may depend on the position of the pixel unit 1101 and the temperature of the photoelectric conversion apparatus, is also substantially equal for both of the valid pixels 11 and the OB pixel 1102. Therefore, the output of the amplification unit 105 of the OB pixel 1102 may be used as the reference voltage to obtain similar effects as those in the second embodiment and the third embodiment.

Note that, the above-mentioned OB pixel 1102 may be any invalid pixel in which the charges corresponding to incident light are not generated or accumulated, and the present invention is not limited to the configuration using the OB pixel 1102. For example, the OB pixel may be changed to a dummy pixel without the photoelectric conversion unit 1103.

### Fifth Embodiment

FIG. 13 is a block diagram for illustrating a configuration example of an imaging system according to a fifth embodiment of the present invention. First, a structure of the imaging system according to this embodiment is described with reference to FIG. 13.

As illustrated in FIG. 13, an imaging system 900 according to this embodiment includes a barrier 901, a lens 902, a diaphragm 903, a solid-state imaging apparatus 904, and an autofocus (AF) sensor 905. The lens 902 is an optical system configured to form an optical image of an object. The barrier 901 is configured to protect the lens 902. The diaphragm 903 is configured to adjust an amount of light that passes through the lens 902. The solid-state imaging apparatus 904 is configured to obtain the optical image of the object, which is formed by the lens, as image signals, and functions as an imaging unit of this imaging system. The AF sensor 905 is the focus position detection apparatus using the photoelectric conversion apparatus described in each of the above-mentioned embodiments, and functions as a focus detection unit of the imaging system 900 according to this embodiment.

The imaging system 900 further includes an analog signal processing apparatus 906, an analog-to-digital (A/D) converter 907, and a digital signal processing unit 908. The analog signal processing apparatus 906 is configured to process signals output from the solid-state imaging apparatus 904 and the AF sensor 905. The A/D converter 907 is configured to subject the signals output from the analog signal processing apparatus 906 to analog-to-digital conversion. The digital signal processing unit 908 is configured to perform various corrections on the image data output from the A/D converter 907 or to perform processing of compressing the data.

The imaging system 900 further includes a memory unit 909, an external interface (I/F) circuit 910, a timing generation unit 911, a general control/calculation unit 912, and a recording-medium control I/F unit 913. The memory unit 909 is configured to temporarily store the image data. The external I/F circuit 910 is configured to communicate to/from an external device such as an external computer 915. The timing generation unit 911 is configured to output various timing signals to the digital signal processing unit 908 and the like. The general control/calculation unit 912 is configured to control various operations and the entire camera. The recording-medium control I/F unit 913 is configured to exchange data with a removable recording medium 914 such as a semiconductor memory, which is configured to record the obtained image data or read out the image data.

Next, photographing operation of the imaging system 900 according to this embodiment is described. When the barrier 901 is opened, the optical image from the object enters the AF sensor 905 via the lens 902 and the diaphragm 903. The general control/calculation unit 912 calculates, based on an output signal from the AF sensor 905, a distance to the object by the above-mentioned phase difference detection method. Thereafter, the general control/calculation unit 912 performs auto-focusing control in which the lens 902 is driven based on a calculation result, it is determined again whether or not the object is in focus, and when it is determined that the object is not in focus, the lens 902 is driven again.

Then, after it is confirmed that the object is in focus, a charge accumulation operation by the solid-state imaging apparatus 904 is started. When the charge accumulation operation of the solid-state imaging apparatus 904 ends, the image signals output from the solid-state imaging apparatus 904 are subjected to predetermined processing in the analog signal processing apparatus 906, and then to the analog-to-digital conversion in the A/D converter 907. The image signals that have been subjected to the analog-to-digital conversion are written into the memory unit 909 by the general control/calculation unit 912 via the digital signal processing unit 908.

Thereafter, the data accumulated in the memory unit 909 is recorded on the recording medium 914 via the recording-medium control I/F unit 913 under control of the general control/calculation unit 912. Alternatively, the data accumulated in the memory unit 909 may be input directly to the external computer 915 or the like via the external I/F circuit 910.

The photoelectric conversion apparatus described in each of the above-mentioned embodiments may be used to form the AF sensor to improve an accuracy of focus detection. Therefore, according to the imaging system in this embodiment using the AF sensor, more accurate focusing may be performed, and hence an image having higher definition may be obtained.

The imaging system described in the fifth embodiment exemplifies an imaging system to which the photoelectric conversion apparatus in each of the embodiments of the present invention is applicable, and the imaging system to which the photoelectric conversion apparatus according to the present invention is applicable is not limited to the configuration illustrated in FIG. 13.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-020294, filed Feb. 4, 2015, which is hereby incorporated by reference herein in its entirety.

What is claimed is:

1. A photoelectric conversion apparatus, comprising:
a pixel unit including a plurality of pixels,
each of the plurality of pixels comprising:
a photoelectric conversion unit configured to generate charges corresponding to incident light;
a charge transfer unit configured to transfer the charges generated in the photoelectric conversion unit to a charge accumulation unit; and
an amplification unit configured to output an output voltage corresponding to the charges accumulated in the charge accumulation unit;
a reference voltage generation unit configured to generate a reference voltage;
a comparison unit configured to output a comparison result by comparing the output voltage from the amplification unit and the reference voltage output from the reference voltage generation unit; and
a control unit configured to control a timing to end the accumulation of the charges in the photoelectric conversion unit based on the comparison result,
wherein the reference voltage to be compared with the output voltage based on the charges transferred from the photoelectric conversion unit to the charge accumulation unit when the charge transfer unit is in a non-conductive state, is a voltage corresponding to charges accumulated in the charge accumulation unit due to a dark current.

2. The photoelectric conversion apparatus according to claim 1, wherein the reference voltage is configured to change with respect to accumulation time of the charges in the photoelectric conversion unit.

3. The photoelectric conversion apparatus according to claim 2, wherein the reference voltage is configured to change linearly with respect to the accumulation time of the charges in the photoelectric conversion unit.

4. The photoelectric conversion apparatus according to claim 3, wherein a slope of the change of the reference voltage with respect to the accumulation time corresponds to a slope of a change with respect to time of the output voltage of the amplification unit generated by the charges accumulated in the charge accumulation unit due to the dark current.

5. The photoelectric conversion apparatus according to claim 1,
wherein the photoelectric conversion apparatus comprises a plurality of pixel units, and
wherein the reference voltage input to the comparison unit included in each of the plurality of pixel units is different for each of the plurality of pixel units.

6. The photoelectric conversion apparatus according to claim 5, wherein the reference voltage input to the comparison unit included in each of the plurality of pixel units is different depending on a distance between each of the plurality of pixel units and the control unit.

7. The photoelectric conversion apparatus according to claim 1, wherein a slope of a change of the reference voltage with respect to accumulation time of the charges in the photoelectric conversion unit is configured to change depending on a temperature of the photoelectric conversion apparatus.

8. The photoelectric conversion apparatus according to claim 1,
wherein the reference voltage generation unit is an invalid pixel in which the charges corresponding to incident light are not generated, and
wherein the reference voltage is a voltage corresponding to the charges accumulated in the charge accumulation unit of the invalid pixel due to the dark current.

9. The photoelectric conversion apparatus according to claim 8, wherein the invalid pixel comprises an optical black pixel in which the photoelectric conversion unit is shielded from light.

10. The photoelectric conversion apparatus according to claim 8, wherein the invalid pixel comprises a dummy pixel without the photoelectric conversion unit.

11. An imaging system, comprising:
a focus detection unit comprising:
a pixel unit including a plurality of pixels,
each of the plurality of pixels comprising:
a photoelectric conversion unit configured to generate charges corresponding to incident light;
a charge transfer unit configured to transfer the charges generated in the photoelectric conversion unit to a charge accumulation unit; and
an amplification unit configured to output an output voltage corresponding to the charges accumulated in the charge accumulation unit;
a reference voltage generation unit configured to generate a reference voltage;
a comparison unit configured to output a comparison result by comparing the output voltage from the amplification unit and the reference voltage output from the reference voltage generation unit; and
a control unit configured to control a timing to end the accumulation of the charges in the photoelectric conversion unit based on the comparison result,
wherein the reference voltage to be compared with the output voltage based on the charges transferred from the photoelectric conversion unit to the charge accumulation unit when the charge transfer unit is in a non-conductive state, is a voltage corresponding to charges accumulated in the charge accumulation unit due to a dark current; and
an imaging unit configured to obtain an optical image of an object.

12. A driving method for a photoelectric conversion apparatus,
the photoelectric conversion apparatus comprising:
a pixel unit including a plurality of pixels,
each of the plurality of pixels comprising:
a photoelectric conversion unit configured to generate charges corresponding to incident light;
a charge transfer unit configured to transfer the charges generated in the photoelectric conversion unit to a charge accumulation unit; and
an amplification unit configured to output an output voltage corresponding to the charges accumulated in the charge accumulation unit; and
a comparison unit configured to output a comparison result by comparing the output voltage from the amplification unit and a reference voltage,
the driving method comprising:
outputting, by the comparison unit, the comparison result obtained by comparing the output voltage based on the charges transferred from the photoelectric conversion unit to the charge accumulation unit when the charge transfer unit is in a non-conductive state, and the reference voltage, which is a voltage corresponding to charges accumulated in the charge accumulation unit due to a dark current; and
ending the accumulation of the charges in the photoelectric conversion unit based on the comparison result.
